(19) United States
(12) Patent Application Publication
(10) Pub. No.: US 2011/0004405 A1
(43) Pub. Date: Jan. 6, 2011

(54) EARTH HORIZON SENSOR

(75) Inventor: Richard A. Hutchin, Calabsas, CA (US)

Correspondence Address: FULBRIGHT AND JAWORSKI LLP, 555 S. FLOWER STREET, 41ST FLOOR, LOS ANGELES, CA, 90071, US

(73) Assignee: Optical Physics Company Inc., Calabasas, CA (US)

(21) Appl. No.: 12/496,610

(22) Filed: Jul. 1, 2009

(51) Int. Cl. G01C 21/00; G01J 5/02; G01V 7/00

(52) U.S. Cl. 701/222; 701/207; 250/353; 702/2

(57) ABSTRACT

An Earth horizon sensor that images the vicinity of the Earth horizon or limb to locate the non-thermal airglow emissions and calculates the orientation of the horizon plane or alternately the vector pointing towards the center of the Earth based on the location of the said airglow emissions. The orientation of the horizon plane in turn can be used to calculate the pitch and roll of the platform upon which the Earth horizon sensor is mounted. Yaw angle can be calculated with an additional celestial reference located in the same image or made available from another source. The orientation of the horizon plane can also be used to calculate the latitude and longitude of Earth coordinates, provided that three axis inertial attitude and time are also available. The Earth horizon sensor can be adapted to operate in space upon spacecraft in Earth orbit or in the atmosphere upon aircraft flying at altitudes of 10K ft or more. For operation in the atmosphere during daytime, the location of the solar scatter peak can be used instead of airglow emission intensity profiles.

### TECHNICAL FIELD

This disclosure relates to an optical sensor. In particular, this disclosure relates to an optical sensor system and method for detection and localization of the Earth from a high altitude vehicle, or a spacecraft in Earth orbit, for detecting the horizon of the Earth to determine the coordinates of the vector that points to the center of the Earth.

### BACKGROUND

Horizon and Earth sensor systems have many applications. An Earth sensor is a critical component in the attitude control system of a spacecraft near Earth. The attitude of the spacecraft is determined by its orientation with respect to three axes at right angles to each other. Two of these axes are in a plane normal to a projected radius of the Earth passing through the spacecraft. These are the pitch and roll axes. The third axis, namely yaw is usually determined by other means, such as a gyroscope, or the observation of stars. Horizon and Earth sensors can also be employed in geo-location. The centuries old sea navigation instrument, the sextant employs horizon sensing at sea combined with localization of the horizon with respect to celestial objects, e.g., Sun, Moon, planets or stars. More modern versions of the sextant have been developed which track the horizon with respect to the stars using sophisticated instruments.

On the ground, Earth horizon sensors would need to detect the interface between the Earth surface and the sky. This interface is often identifiable if the Earth surface meeting the sky is flat, e.g., at sea, but is not so clearly identifiable if the surface has contours, e.g., mountains. For this reason, on the ground, tiltmeters or inclinometers are used to locate the perpendicular to the horizon. In air, Earth horizon sensing is delegated to gyroscopes or inertial measurement units (IMU's). In space, Earth horizon sensors detect the interface between the Earth's edge (or limb) and the space background. Space based Earth horizon sensors can detect the Earth's visible limb (e.g., albedo sensor), or the Earth's infrared limb formed by the edge between warm Earth and cold space background.

The two main categories of Earth horizon sensors are scanning and staring (or static) types. The scanning sensor mechanically scans the Earth to detect the horizon crossings and measure the time between horizon crossings. The time between two crossings, one coinciding with the transition from space background to Earth and the other from Earth to space background is proportional to the angular radius of the Earth. In the staring (or static) type horizon sensor the horizon is imaged onto a detector array in a manner that allows the edge of the Earth to be determined from the image. A staring Earth sensor often views a field of view larger than the entire limb of the Earth.

Many Earth sensors in use today are scanning sensors with narrow fields of view. Accuracies for Earth sensors are in the 0.1 to 1 degree range. Locating the horizon of the Earth from space makes it possible to locate the vector that points to the center of the Earth, which in turn, makes it possible to determine the spacecraft's attitude with respect to Earth coordinates. Knowing the orientation of a vector pointed towards the center of Earth with respect to at least two cataloged stars makes it possible to determine the latitude and the longitude of the Earth location directly beneath the spacecraft from a star almanac provided that one also has an accurate time measurement since star almanacs are time dependent.

### SUMMARY OF THE INVENTION

The present invention is directed towards a staring Earth horizon sensor. The sensor includes a means for detecting and imaging the non-thermal radiation emissions from a reaction that takes place in the atmosphere around 70-90 km above Earth known as airglow.

Several optical modifications may be incorporated into such a sensor to accommodate operation in the atmosphere at high altitude, or in space in low Earth orbit or high Earth orbit. The Earth horizon sensor can be utilized to determine the attitude of an aircraft or a spacecraft with respect to the Earth horizon, which yields pitch and roll angles. A celestial reference point can be used to calculate yaw, thus completing all attitude measurements. As another option, a star sensor can be combined with the Earth horizon sensor for geo-location that does not require any external navigational signals, such as Global Positioning System (GPS), GLONASS or Galileo.

Accordingly, an improved Earth horizon sensor is disclosed. Advantages of the improvements will appear from the drawings and the description of the preferred embodiments.

### BRIEF DESCRIPTION OF THE DRAWINGS

In the drawings, wherein like reference numerals refer to similar components:

FIG. 1A schematically illustrates a view of the Earth and the surrounding airglow ring from space;

FIG. 1B shows the spectral content of airglow emissions;

FIG. 1C shows the intensity profile of the airglow along a line through the center of the Earth;

FIG. 2A is a plot of the intensity profile of a vertical column of nighttime radiance in the airglow spectral band;

FIG. 2B is a plot of the intensity profile of a vertical column of daylight radiance in the airglow spectral band;

FIG. 3A illustrates a composite Earth horizon sensor comprising a group of Earth horizon imagers, in accordance with the disclosure, adapted to view a composite field of view;

FIG. 3B illustrates a horizon imager in accordance with the disclosure.

FIG. 3C schematically illustrates an alternate single imager implementation of the Earth horizon sensor of this disclosure, adapted for a single wide field of view;

FIG. 4A and FIG. 4B illustrate images of the horizon obtained by the Earth horizon sensor of this disclosure adapted for airborne platforms, during night and day, respectively:

FIG. 5A geometrically illustrates how horizon images captured by the Earth horizon sensor of this disclosure adapted for airborne platforms can be used to calculate the pitch and roll angles of the airborne platform;

FIG. 5B provides a flowchart of the method for calculating the pitch, roll and yaw angles;

FIG. 5C geometrically illustrates the scenario for determining the Earth coordinates using images obtained with the Earth horizon sensor of this disclosure;

FIG. 6 provides a flowchart of the method for calculating inertial attitude and the Earth coordinates (latitude and longitude coordinates) using images obtained with the Earth horizon sensor of this disclosure:

FIG. 7A schematically illustrates the Earth horizon sensor of this disclosure, adapted for spacecraft platforms situated in Earth orbit with an altitude of 10,000 km or more:

FIG. 7B illustrates the Earth and spacecraft viewing geometries associated with using the Earth horizon sensor in Geostationary Orbit (GSO);

FIG. 7C illustrates an image of the Earth, the airglow around Earth and celestial objects obtained by the Earth horizon sensor of this disclosure adapted for spacecraft platforms situated in Earth orbit with an altitude of thousands of kilometers or more:

FIG. 7D shows the intensity profile of the airglow in the vicinity of the Earth's limb:

FIG. 8 geometrically illustrates how images captured by the Earth horizon sensor of this disclosure adapted for spacecraft in Earth orbit can be used to calculate the pitch, roll and yaw angles of the spacecraft;

FIG. 9 schematically illustrates an alternate high precision embodiment of the Earth horizon sensor of this disclosure adapted for spacecraft platforms situated in Earth orbit with an altitude of thousands of kilometers or more;

FIG. 10A and FIG. 10B schematically illustrate a high precision embodiment of the Earth horizon sensor of this disclosure adapted for spacecraft platforms situated in Earth orbit with an altitude of hundreds of kilometers;

FIG. 10C illustrates an image of a portion of the Earth limb, the airglow around the Earth and celestial objects in the field of view obtained by a horizon imager element;

FIG. 11A schematically illustrates an alternate high precision implementation of the Earth horizon sensor of this disclosure adapted for spacecraft platforms situated in Earth orbit with an altitude of hundreds of kilometers;

FIG. 11B illustrates the arrangement and the field of view tilts of the individual horizon imager elements of the Earth horizon sensor embodiment of FIG. 11A.

### DETAILED DESCRIPTION OF THE PREFERRED EMBODIMENTS

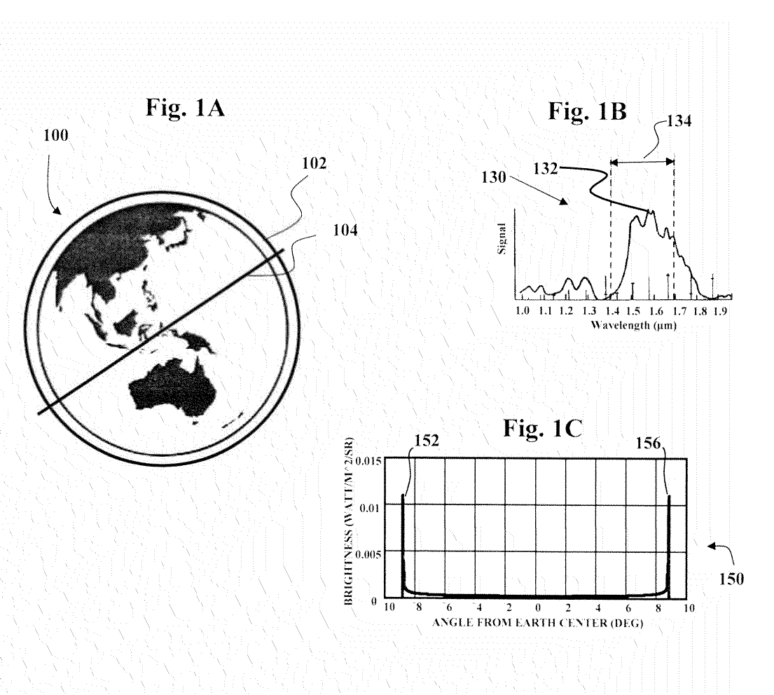

Turning in detail to the drawings, FIG. 1A illustrates a view of the Earth 100 from space. The terrestrial globe is surrounded by an atmosphere within which many chemical reactions take place. One distinct phenomenon called “airglow” is non-thermal radiation emitted by the Earth's atmosphere as a result of the transitions between vibrational states of the hydroxyl (OH—) radical. Measured heights of airglow range between 70 and 90 km altitude. Airglow occurs at all latitudes and surrounds the Earth 100 It can be observed in the form of an airglow ring 102. FIG. 1B illustrates a spectrum 130 of airglow emissions. One spectral peak 132 occurs near a wavelength of 1.6 microns in an airglow spectral band 134. By imaging the airglow spectral band 134 in the spectral region of the peak 132 in a focal plane detector array of pixels, and processing the image by digitizing the intensities of pixel signals, a computer can analyze the detected array of signals to obtain a complete image from space of the airglow ring 102 encircling the limb of the Earth. A line 104 (FIG. 1A) going through the center of the Earth 100 and intersecting the airglow ring 102 will have an intensity profile 150 illustrated in FIG. 1C. Two peaks (152, 156) of the intensity profile 150 coincide with the altitudes where the airglow emissions occur. In case of an imager placed in geosynchronous orbit about 36,000 kilometers above Earth with the airglow imager looking directly down at nadir (local vertical direction pointing in the direction of the force of gravity at that location) the peaks (152, 156) will occur at approximately nine degrees to the right and the left of center within the field of view.

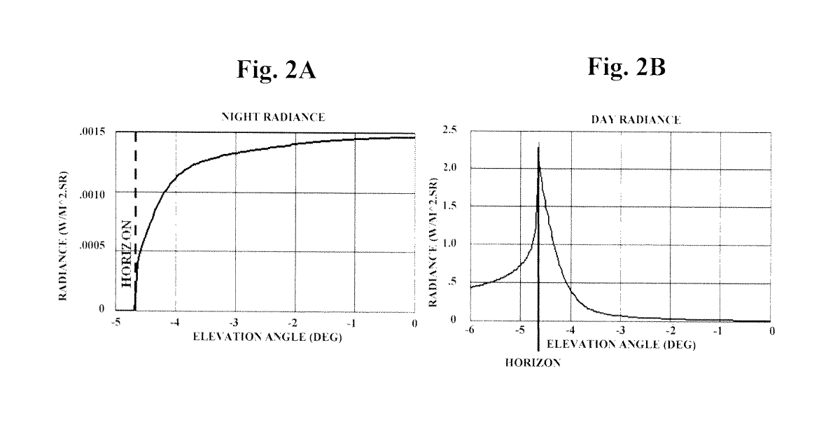

Airglow is also observable from within the atmosphere using a detector configured to register light in the airglow spectral band 134. FIG. 2A shows night time airglow intensity (in the airglow band 134) seen from approximately 70,000 ft as a function of elevation angle, measured relative to absolute horizontal (0 degrees). The Earth horizon is about −4.7 degrees relative to absolute horizontal at that altitude. During daytime, sky radiance below the horizon is much brighter at wavelengths corresponding to the airglow spectral band 134, so it is not practical to register airglow alone. Instead of airglow, a day radiance profile in the airglow spectral band 134 can be used to locate the horizon during daylight hours. The day radiance profile in the airglow spectral band 134 at the same altitude of 70,000 ft is illustrated in FIG. 2B. Again, the intensities along a vertical column of the airglow spectral band 134 have been plotted as a function of elevation angle. In both daylight and night time the horizon can be located using a matched filter of curves from approximately −5 degree to 0 degree elevation. Accurate sky glow models can be used to refine a shape of the matched filter and better model background levels. Terrain and cloud effects at lower elevations will not corrupt measurements. Azimuthal integration can be used to smooth local effects of atmospheric inhomogeneity.

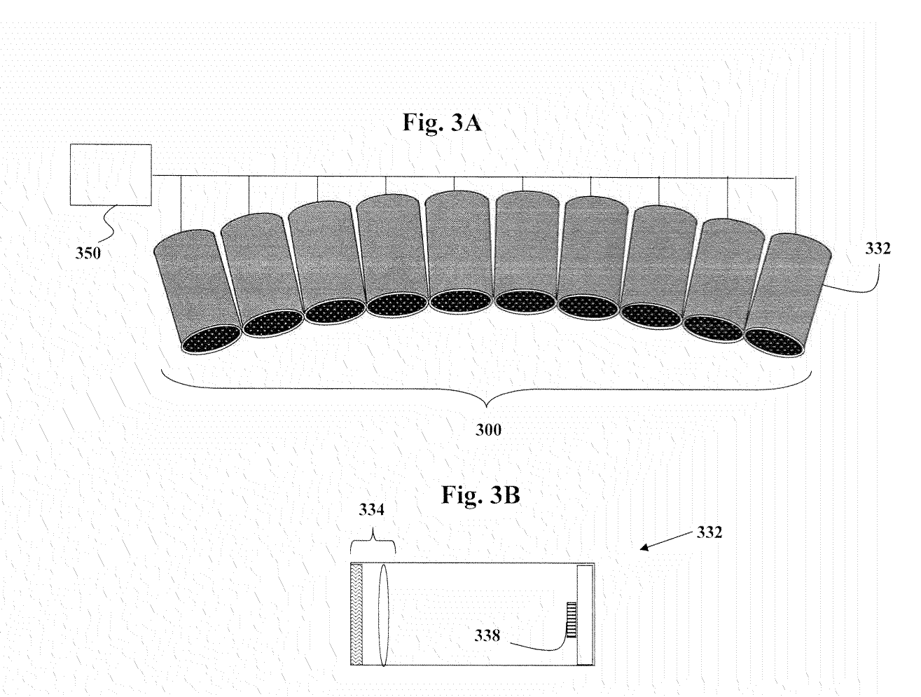

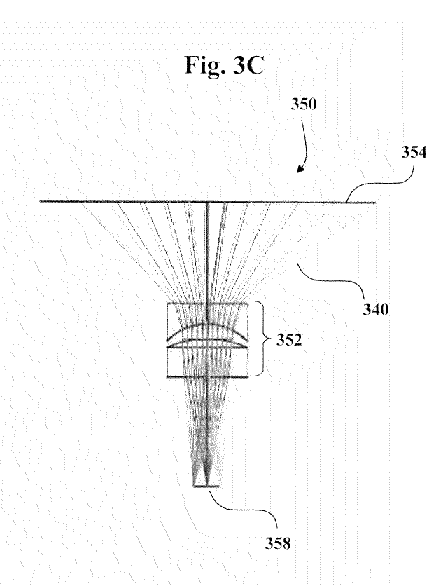

FIGS. 3A and 3B illustrates an embodiment of a composite Earth Horizon sensor 300 using the horizon imager 332 of this disclosure, adapted to view a composite field of view. The composite Earth horizon sensor 300 comprises an array of individual horizon imagers 332 that are arranged in an arc. In the example shown in FIG. 3A, each horizon imager 332 may have, for example, a field of view of about 12 degrees. When ten horizon imagers 332 may be arranged to have non-overlapping concatenated fields of view, the result is substantially a 120 degree field of view of the horizon. This corresponds to a 120 degree azimuthal integration which is sufficient to smooth the local effects of atmospheric inhomogeneity. The FPA 338 of each horizon imager 332 is coupled to a computer 350, where the intensities of the signals detected by pixels of the FPA 338 in the airglow spectral band 134 are digitized, and a computer can analyze the detected array of signals from the images focused on each of the FPAs 338 to locate the Earth horizon on that basis. The horizon imager 332, illustrated in FIG. 3B, comprises a lens system 334 that collects and focuses the light arriving from the vicinity of the horizon, onto a focal plane array 338. Focal plane array light detectors are well known in the art of light sensing. The focal plane array 338 is preferentially configured to sense light primarily in the airglow band 134, typically by means of a spectrum selective filter (not shown) between the incident light and the surface of the focal plane array 338. This type of spectrally selective light collection can be accomplished using a variety of means, such as special detectors or spectral filters, which are familiar to those skilled in the art.

FIG. 3C illustrates a schematic of an alternate embodiment of an Earth horizon sensor 350 using a single focal plane array 358 with a complex optical lens 352 to obtain a near 120 degree field of view image of the horizon. The rays 340 arriving from the vicinity of the horizon that are incident on a window 354 are imaged onto a single focal plane array 358.

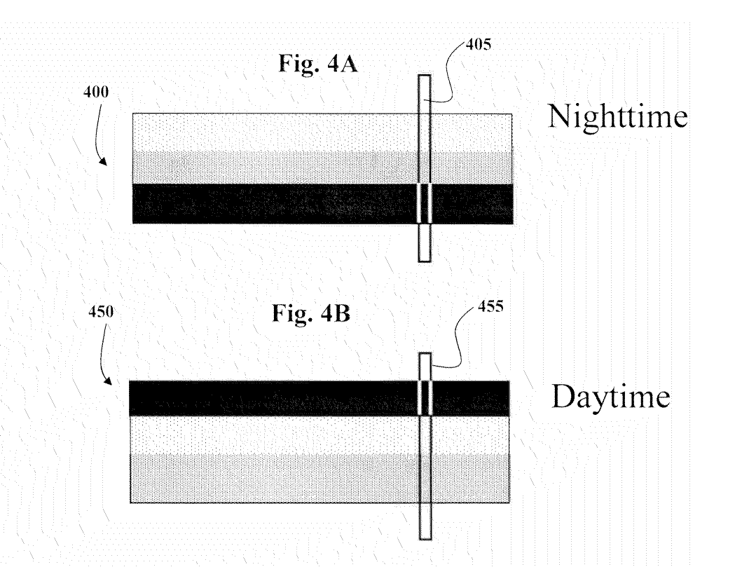

Sample images registered by the composite Earth horizon sensor 300 or by the horizon imager 332, that may be mounted, for example, on an aircraft at high altitude are shown in FIGS. 4A and 4B. Night time image 400 is shown in FIG. 4A. A vertical profile 405 through the image would be comparable to the intensity profile shown in FIG. 2A. The daytime image 450 is shown in FIG. 4B. A vertical profile 455 through the image would be comparable to the intensity profile shown in FIG. 2B. Measured positions and orientations of the intensity profiles can be used to determine the pitch and roll of the aircraft platform on which the Earth horizon sensor 300 is mounted.

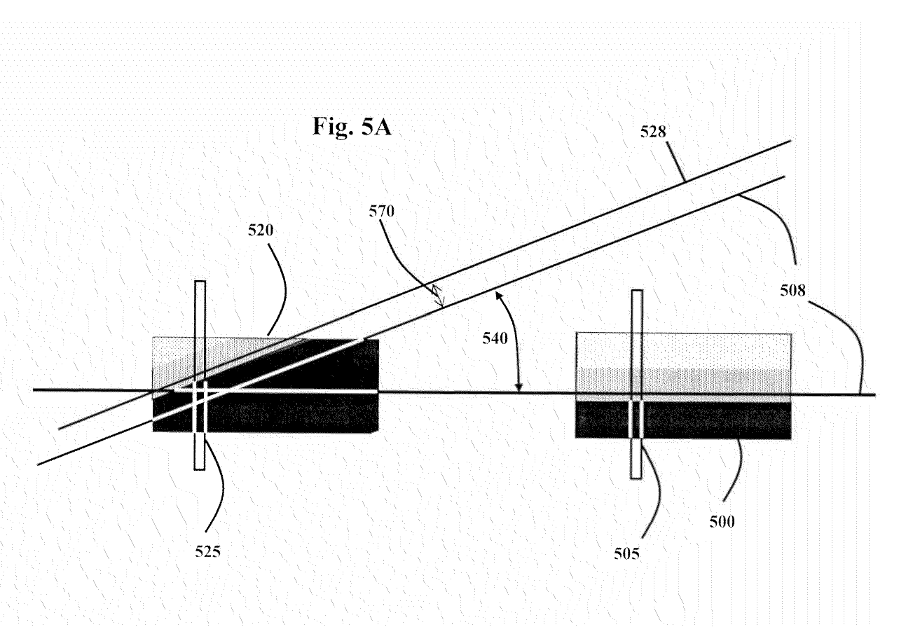

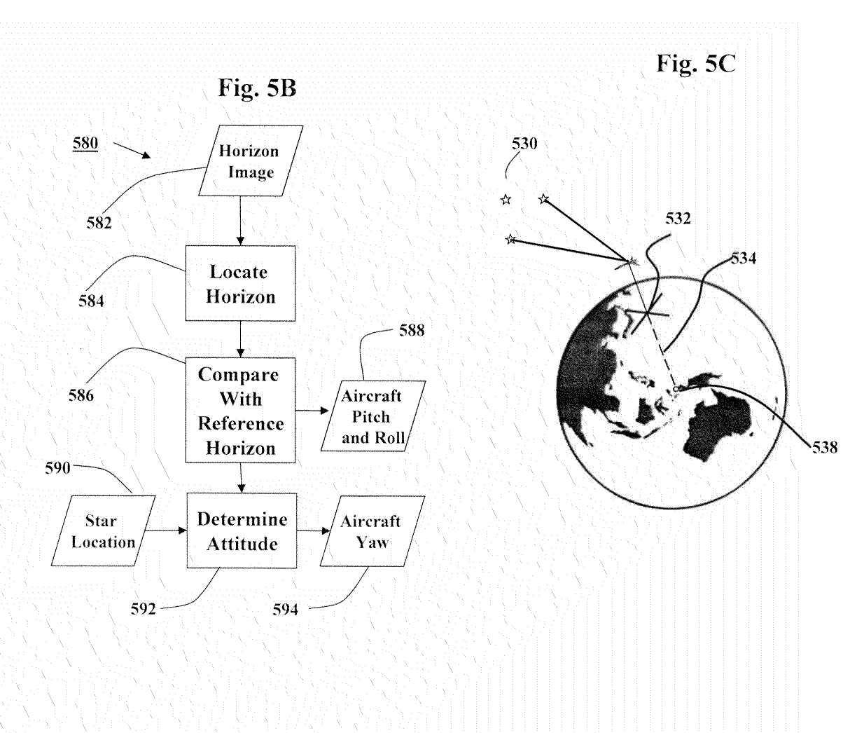

FIG. 5A illustrates features of a quantitative method 580 for calculating the pitch, roll and yaw of the aircraft. A reference horizon image 500 would be obtained at zero pitch and zero roll angles having, for example, a reference horizon profile 505, with an identified reference horizon 508. An observed horizon image 520 has an observed profile 525 and an observed horizon 528 which is at an angle of rotation 540 relative to the reference horizon profile 505. Comparing the observed horizon image 520 and profile 525 with the reference horizon image 500 and profile 505, one can readily observe that the pitch of the aircraft causes the observed horizon image 520 and profile 525 to be rotated in comparison to the reference horizon image 500 and profile 505. The relative angle of rotation 540 between the observed horizon image 520 and profile 525 and reference horizon image 500 and profile 505 can be used to calculate the actual aircraft pitch. Roll of the aircraft, on the other hand, causes the observed horizon profile 525 to be displaced with respect to the reference horizon profile 505. The measured displacement 570 can be used to calculate the aircraft roll.

To complete the three dimensional attitude measurement of the aircraft with respect to the horizon, namely to measure the yaw, one additional reference point is needed. The additional reference can be provided by observing a known celestial body (e.g., a star) and determining its location with respect to the observed horizon 528. The celestial body can be the Sun or a star that is present in the observed horizon image 520. Alternately, the celestial body can be located by another observation or by another one or more of the horizon imagers 332 (FIG. 3A).

A method 580 of determining aircraft pitch, roll, and yaw is illustrated in FIG. 5B, referring to FIG. 5A. An observed horizon image 520 (data block 582) is acquired by the horizon sensor 300 (FIG. 3A). The observed horizon image 520 is provided by a computer 350 coupled to the focal plane array 358 of each horizon imager 332 of the horizon sensor 300 to locate the observed horizon 528 (process block 584). The observed horizon 528 is compared with the reference horizon 508 for angle of rotation 540 and displacement 570 (process block 586) to determine the aircraft pitch and roll (data block 588). Three dimensional attitude (i.e., roll, pitch and yaw) is completed by determining the location of the observed horizon 528 with respect to an identified celestial body present in the observed horizon image 520, where, for example, the celestial body is the Sun or a star identified in a star locator map or catalog (data block 590). The star location is combined (in process block 592) with the reference horizon 508 using well known computational methods and calculations of celestial navigation to determine the third aircraft attitude parameter, i.e., by generating the aircraft yaw (in data block 594). THE COMPLETE ON-BOARD CELESTIAL NAVIGATOR, by George Bennett, (International Marine/Ragged Mountain Press; 1st edition. Dec. 4, 2006), provides examples of the astrophysical and celestial calculations that may be implemented on the computer 350 to complete the determination of pitch, roll and yaw, and other parameters, such as latitude and longitude, as discussed below.

As illustrated in the drawing in FIG. 5C, the Earth horizon sensor 300 can also be used for calculating the latitude and the longitude of the coordinates of a point 532 on the ground directly underneath the high altitude aircraft containing the Earth horizon sensor 300. A point 532 is defined as the intersection of the surface of the Earth and a line 534 drawn between the Earth horizon sensor 300 and the center 538 of the Earth. The latitude and longitude calculation also requires determining attitude in inertial space which can be obtained by processing the image from a separate star sensor (not shown) that is configured to image a star field 530. In this case, the boresight of the star sensor and the boresight of the Earth horizon sensor 300 must be referenced to each other.

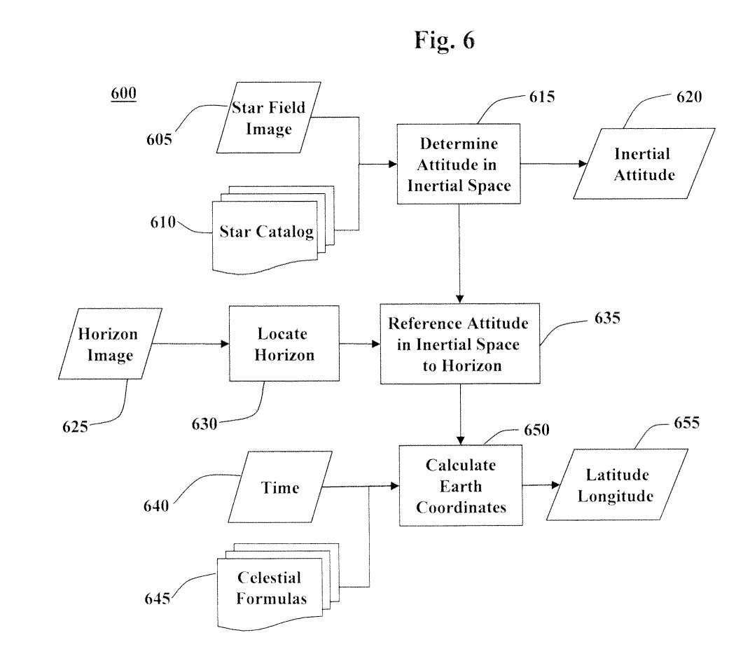

FIG. 6 illustrates a method 600 of determining the latitude and longitude of the coordinates of a point 532 on the ground directly beneath the high altitude aircraft. All calculations (e.g., processing) are performed by a computer (e.g., 350, FIG. 3A). A star sensor obtains an image of the star field (data block 605). At least two identifiable celestial objects as determined, for example, by reference to a Star Catalog (data block 610) in the field of view define a three axis attitude in inertial space. The inertial attitude (data block 620) of the star sensor relative to the identified celestial objects may then be determined (process block 615). When a horizon image (data block 625) is acquired by the Earth horizon sensor 300, the image may be processed to locate the horizon in process block 630. With the boresights of the star sensor and the Earth horizon sensor 300 referenced to each other, the inertial attitude may be referenced to the horizon (process block 635). When one combines the output of the three axis attitude in inertial space determination (process block 615) with the attitude with respect to the horizon calculated in process block 630 using the Earth horizon sensor 300 horizon image (data block 625) and the time measurement of the observation (data block 640), it becomes possible, with the aid of calculations based on celestial formulas (data block 645) to calculate Earth coordinates (process block 650) to determine the latitude and longitude (data block 655) of the location situated directly under the aircraft. The celestial formulas (such as described by Bennett) for Earth orientation as a function of time (process block 645) are required in the calculation (process block 650) of Earth coordinates, i.e., longitude and latitude (data block 655) since positions where stars are observed change as the Earth rotates on its axis and around the Sun.

Alternately, the star field 530 can be registered by the Earth horizon sensor 300 in the same field of view. In this case a separate star sensor is not needed, and since the Earth horizon sensor 300 is configured to image light primarily in the airglow spectral band 134, the star field 530 would also be imaged in the same spectral band.

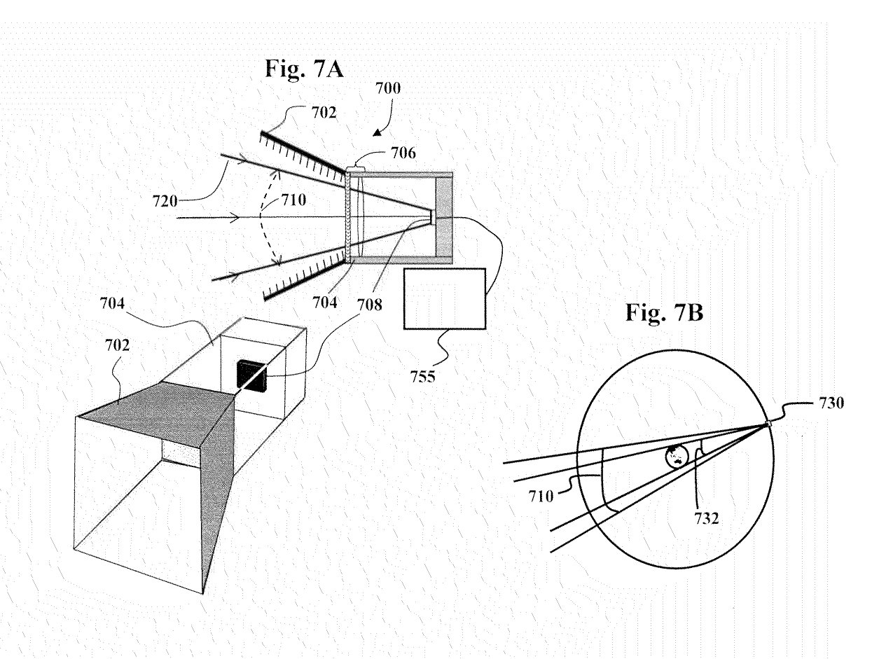

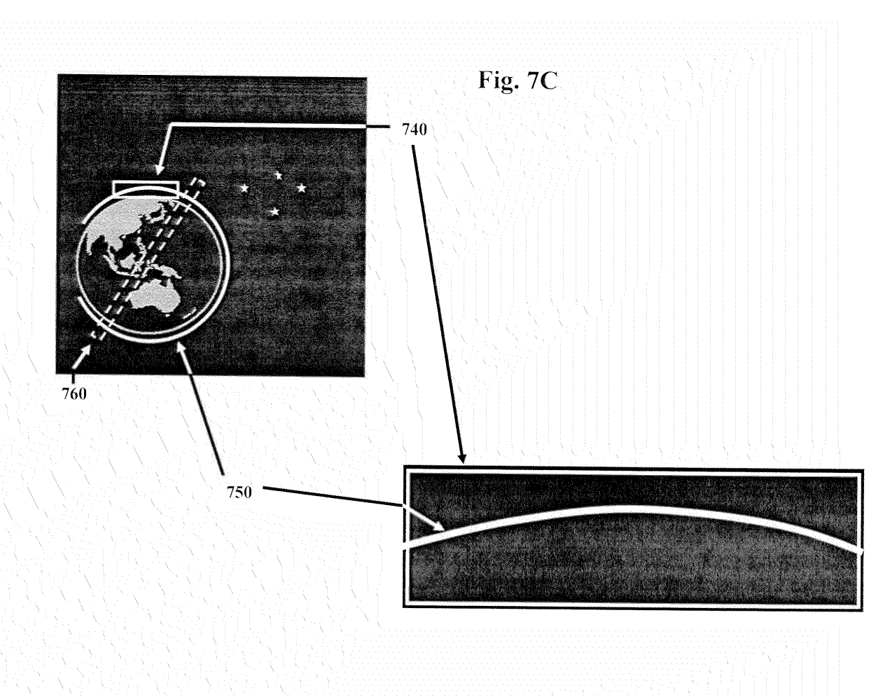

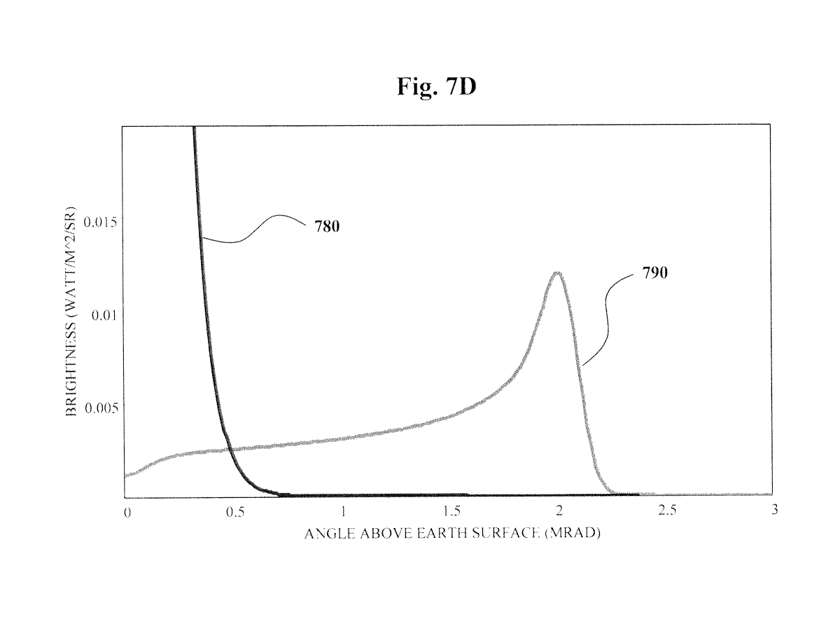

FIG. 7A illustrates another embodiment of an Earth horizon sensor 700. The Earth horizon sensor 700 is configured for operation from space, preferably on a spacecraft positioned in orbit with an altitude of tens of thousands of kilometers. This type of high Earth orbit space based Earth horizon sensor 700 comprises front-end optical components 706 that collect and focus the light for imaging onto a focal plane array (FPA) 708 for sensing light primarily in the airglow spectral band 134. The FPA 708 is often coupled to circuits that digitize the pixels of the FPA 708 (such as with analog-to-digital (A/D) converters) and communicate them to a computer 755 that processes the digital signals to determine the spacecraft position and attitude based on the image location of the airglow ring 102 (FIG. 1A). Furthermore, a sun shade 702 and a space qualified casing 704 can be added to protect these components. Rays 720 arriving from the vicinity of the Earth that are incident on the window front-end optics 706 are thus imaged onto the FPA 708. A field of view 710 is preferably wide enough to image the entire Earth 100. An example imaging geometry is illustrated in FIG. 7B. In the illustrated geometry, the Earth horizon sensor 700 is mounted on a spacecraft 730 in geosynchronous orbit (GSO) about 36,000 kilometers above Earth. When viewed from this orbit, the Earth field of view 732 is about 17.5 degrees. This is preferably smaller than the field of view 710 of the Earth horizon sensor 700. FIG. 7C illustrates a sample image that can be obtained using the Earth horizon sensor 700 in this geometric configuration. The image captures the airglow as a thin airglow arc 750 around the Earth at the expected 70-90 km altitude. A detail region 740 shows the airglow in greater detail. Even though the airglow region surrounds the Earth completely, some parts of the airglow may not be registered due to the pointing angle of the spacecraft, presence of the Sun or Moon, occlusions, or other reasons. An intensity profile registered in a columnar group of pixels 760 going through the center of the airglow arc will have a shape similar to the profile 150 shown in FIG. 1C. An increased detail of the airglow intensity profile is shown in FIG. 7D with respect to a solar scatter intensity 780 in the airglow spectral band 134 which would also be registered by the Earth horizon sensor 700. The location of the solar scatter 780 in the airglow band 134 is quite distinct from the peak of the airglow intensity profile 790. The airglow peak location is located approximately 2 milliradians above the Earth surface (assuming viewing location at GSO).

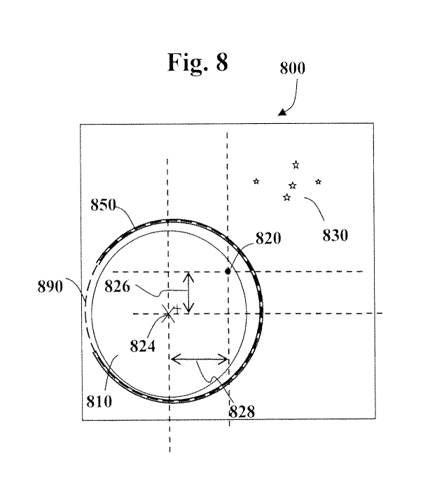

FIG. 8 illustrates a sketch of the sample image 800 illustrated in FIG. 7C overlaid onto a reference coordinate system with a center 820 and the hard body of the Earth sphere 810. The coordinates of the airglow arc 850 can be used to identify the coordinates of the complete airglow ring 890. The coordinates of the airglow arc 850 or the airglow ring 890 can be used to identify coordinates of the hard body of the Earth sphere 810 and the Earth center 824. This computation may take several factors into consideration, such as the season, the time of day, maps and intensity profiles of the airglow, temperature, location of the Sun and the Moon, volcanic activity, etc. The center (marked with “+” in FIG. 8) of the airglow ring 890 may or may not coincide with the coordinates of the center 824 (marked with “x” in FIG. 8) of the hard body of the Earth sphere 810 due to variations of the airglow altitude. The reference center 820 is selected to coincide with the Earth center 824 if the spacecraft had a particular orientation, assumed to be zero pitch and zero roll angles for convenience. The difference (828, 826) between the coordinates of the Earth center 824 and the reference center 820 can be used to calculate a pitch and a roll of the spacecraft. The coordinates of a star field 830 can be used to identify a yaw angle. The star field 830, provided that it consists of at least two identifiable stars, also defines a three axis attitude in inertial space. When one combines the three axis attitude in inertial space with the attitude with respect to the Earth center 824 and the time of the observation, it becomes possible to calculate the latitude and longitude of the location on Earth that the spacecraft is directly over. Star catalog data and formulas for Earth orientation as a function of time are required in this calculation, where such data and formulas may be stored in a computer memory and operable on a computer 350.

The calculation of latitude and longitude requires accurate horizon location, accurate star position location, and precise locking of the star coordinates with the horizon. Each microradian of error in these measurements from an Earth horizon sensor (e.g., 700, FIG. 7A) in GSO translates to about 41 meters error in position location on the Earth.

For part of the year, the Sun or the Moon will be in the field of view 720 up to twice per day for up to 4 minutes per 24 hour rotation of the Earth. In GSO the choices are to accept an outage and extrapolate orbital geolocation data over the outage, or to create a movable internal stop to block the Sun or Moon portion of the Earth image. In lower Earth orbits, this issue is resolved by use of multiple sensors, one or two of which will be occasionally blinded and not included in the calculations.

The angular size of the observed airglow arc 850 provides a basis for estimating the altitude of the spacecraft. The smaller the angular size, the higher the altitude of the spacecraft will be. The altitude accuracy is dependent upon the accuracy in the diameter of the observed airglow arc 850.

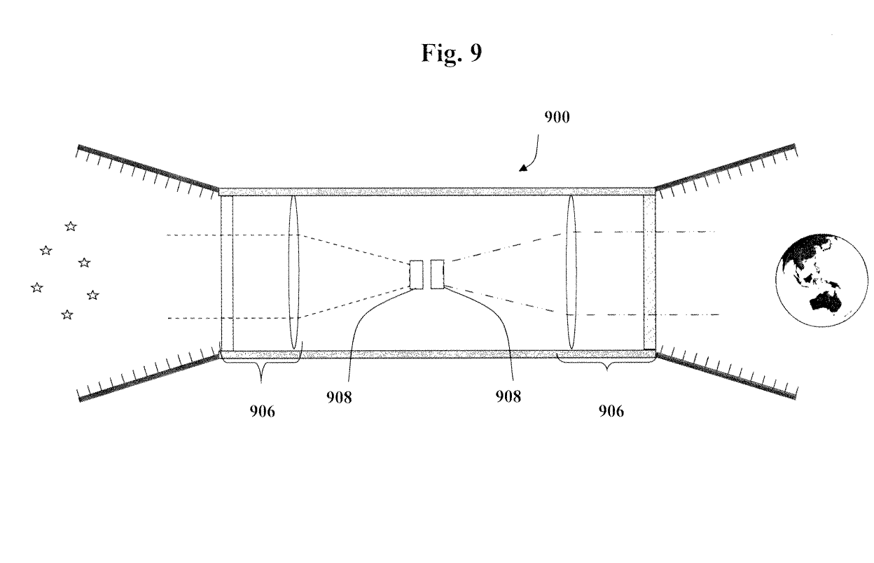

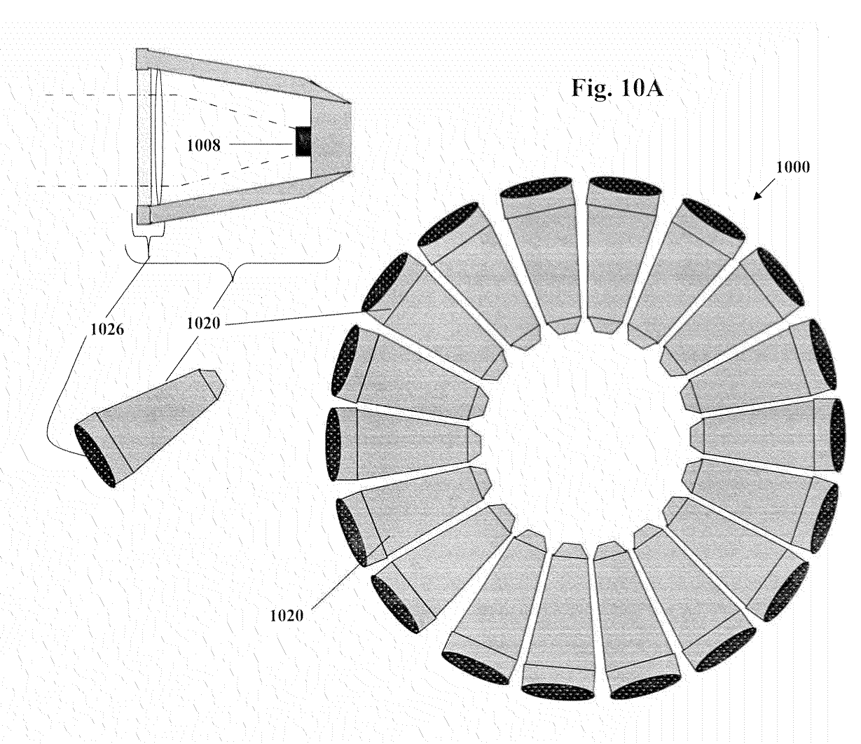

FIG. 9 illustrates an alternate embodiment of an Earth horizon sensor 900 that separates the Earth horizon sensing from the star or celestial object sensing. Two high Earth orbit high precision Earth horizon sensors 700 (FIG. 7A) are combined, but only one of them is used to image the Earth airglow 102. The other is used to track a star or other celestial object. In the exemplary embodiment shown in FIG. 9, the two sensors are configured such that one faces towards Earth and the other substantially in the opposite direction, where each sensor has a corresponding set of optics 906 and a FPA 908. This arrangement can be changed so that the sensor viewing the stars can assume any arbitrary viewing angle with respect to the Earth viewing sensor. As an option, the precise arrangement geometry can be continuously monitored using an appropriate tracking device that determines the alignment of the two sensors' front-end optical components 906. This tracking allows precise alignment of the two sensors' boresights and the registration of the two images to one another. Since the FPA 908 of the sensor used for viewing the star field need not be configured to register light primarily in the airglow spectral band 134, the star field sensor FPA 908 can be replaced with one that registers light in another suitable spectral band for starlight, e.g., visible band (0.4-0.8 microns).

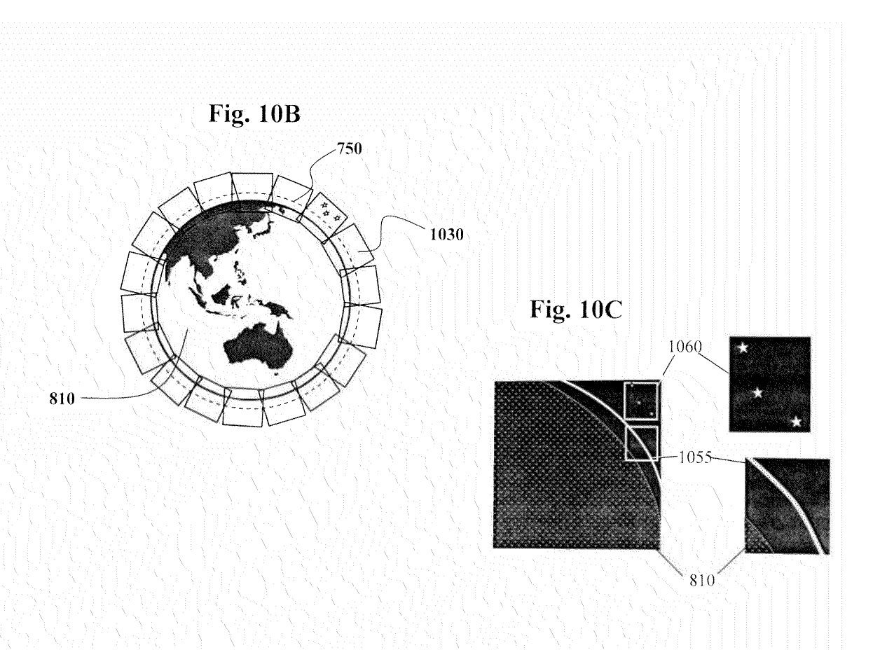

The Earth horizon sensor of this invention can be adapted to operate in a lower Earth orbit than GSO, e.g., LEO. Viewing the Earth and the airglow ring around the Earth at lower altitudes will require a broader field of view, e.g., 120 degrees. FIGS. 10A-10C illustrate a composite Earth horizon sensor 1000 configured for operation on spacecraft positioned in Earth orbits with altitudes of hundreds of kilometers. The composite Earth horizon sensor 1000 is comprised of a plurality of horizon sensors 1020. FIG. 10A illustrates an embodiment of the low Earth orbit composite Earth horizon sensor 1000 looking, for example, down towards Earth. One or more of the horizons sensors 1020 may also observe stars in the field of view. The low Earth orbit composite Earth horizon sensor 1000 may consist, for example, of 18 horizon sensors 1020 each with front-end optical components 1026 and an FPA 1008. The horizon sensors 1020 are arranged in a circle and directed to view a portion of the airglow arc 750 (FIG. 7C), that is, directed toward a portion of the horizon at an angle appropriate for the spacecraft altitude. Each horizon sensor 1020 has a 20 degree field of view, and 18 of them are concatenated to cover the full 360 degrees. i.e., to cover the full Earth horizon. FIG. 10B illustrates the individual horizon imager fields of view 1030 covering the entire Earth horizon. FIG. 10C shows an example of an image obtained by a single Earth horizon sensor 1020 containing an arc segment of the airglow arc 750 and an underlying segment of the hard body of the Earth 810 (FIG. 8). The image may also contain celestial objects, e.g., other spacecraft or stars. FIG. 10C also illustrates a sample image captured by a single horizon sensor 1020. The airglow arc detail 1055 and a star detail 1060 further illustrate this phenomenon.

Each horizon sensor 1020 unit sees, for example, about 20 degrees which includes earth, airglow and, in some instances, a local star field (i.e., near the Earth horizon). The stars observed in the local star field may be identified with star maps in computer memory and can be tracked relative to the outer edge of the air glow. The stars provide the attitude in inertial space and the airglow provides the horizon plane orientation.

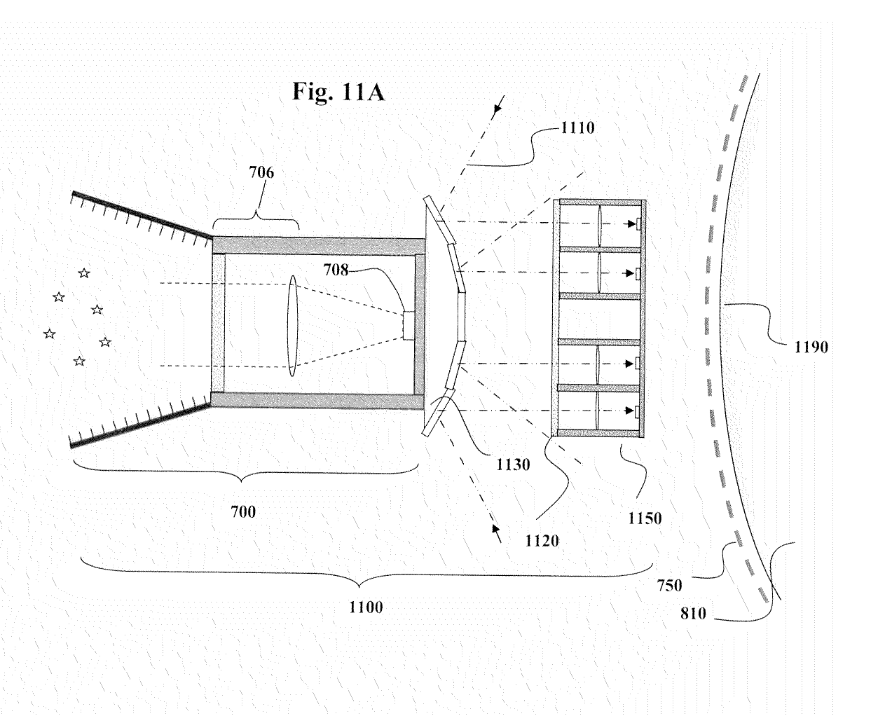

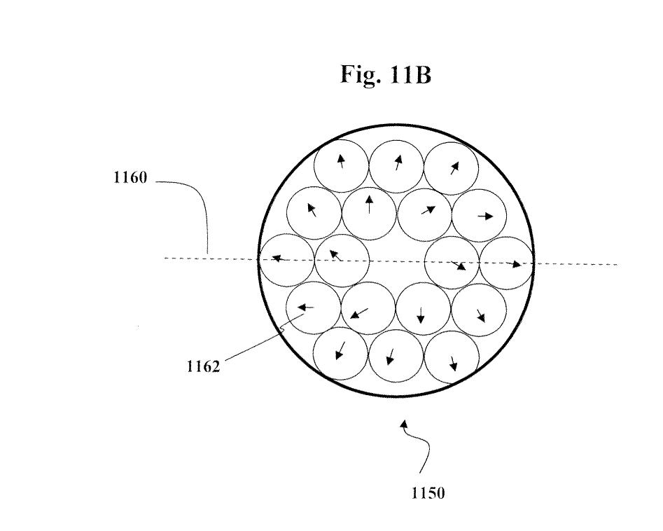

FIG. 11A illustrates another embodiment of a low Earth orbit (LEO) integrated Earth horizon sensor 1100. This LEO integrated Earth horizon sensor 1100 separates the Earth horizon imaging function from the star or celestial object imaging. As shown in FIG. 11A, 18 FPAs are combined into an integrated Earth horizon FPA configuration 1150 in a manner that allows them to share a common front-end optical system 1120. FIG. 11A shows a cross-section cut through the configuration 1150 of 18 horizon sensors (e.g., horizon sensors 1020 of FIG. 10A) and the common front-end optical system 1120. Another view of the 18-horizon imager configuration 1150 is illustrated in FIG. 11B. The drawing of the integrated Earth horizon sensor 1100 in FIG. 11A is a cross section along the axis labeled 1160 in FIG. 11B. Referring again to FIG. 11A, the integrated Earth horizon FPA configuration 1150 faces away from Earth and receives the rays 1110 emanating from the vicinity of the Earth's limb 1190 and the airglow arc 750 after they reflect from a multi-faceted mirror 1130. The orientation of the facets of the mirror 1130 causes tilts 1162 in the field of view of the individual horizon imagers as marked in FIG. 11B with arrows.

To add star sensing capability, a single one of the Earth horizon sensors (e.g., 700, FIGS. 7A and 11A) is configured to point in the direction away from Earth to view other celestial objects or stars. This arrangement can be changed so that the selected Earth horizon sensor 700 viewing the stars can assume any arbitrary viewing angle with respect to the Earth-viewing composite Earth horizon sensor 1000 (FIG. 10A) of eighteen horizon imagers 1020. As an option, the precise arrangement geometry can be continuously monitored using an appropriate tracking means that determines the alignment of the star facing sensor 700 and the Earth-viewing composite Earth horizon sensor 1000. This tracking allows precise alignment of the two sensors' boresights and the registration of the two images to one another. As mentioned earlier with the GSO implementation 700 in FIG. 7A, since the FPA 708 (FIG. 11A) of the Earth horizon sensor 700 used for viewing the star field need not be configured to register light primarily in the airglow spectral band 134, the FPA 708 of the star viewing sensor 700 can be replaced with one that registers light in another suitable spectral band, e.g., visible band (0.4-0.8 microns).

In between LEO and GEO, the number of star tracker modules used will depend on the range to the earth and on the accuracy desired. The cone angle between the different star trackers will also decrease with higher altitude until the entire field of view fits within a single star tracker.

Thus, an Earth horizon sensor system and method for attitude and Earth-centric localization are disclosed. While embodiments of this invention have been shown and described, it will be apparent to those skilled in the art that many more modifications are possible without departing from the inventive concepts herein. The invention, therefore, is not to be restricted except in the spirit of the following claims.

What is claimed is:

1. An Earth horizon sensor device comprising:
at least one optical component for collecting and focusing an airglow light due to near infrared non-thermal emissions in Earth's atmosphere;
at least one detector array coupled to the optical components, the array for receiving a focused image of the airglow; and
an image processing computing system coupled to the at least one detector array for determining coordinates of a vector that points from the device to the center of the Earth on the basis of the airglow imaged on the array.

2. The sensor of claim 1 wherein the detector array receives the image of the solar scatter in the atmosphere in the near infrared band, and the coordinates of the vector pointing to the center of the Earth are determined on the basis of the near infrared solar scatter imaged on the array.

3. The sensor of claim 1 further comprising:
the image process computing system further adapted for determining a roll and pitch of the sensor on the basis of the imaged airglow.

4. The sensor of claim 1 further comprising:
the image processing computing system further adapted for estimating an altitude of the device above the Earth's surface on the basis of the shape and size of the airglow imaged by the sensor.

5. The sensor of claim 1 further comprising:
at least one detector array and optical component adapted for imaging a star field of at least two stars; and
the image process computing system further adapted for identifying the stars in the star field and determining the attitude of the device in inertial space on the basis of the imaged star field.

6. The sensor of claim 5 further comprising:
the image processing computing system adapted for aligning the image obtained by the at least one detector array and component that images the star field being to the image obtained by the at least one detector array and optical component that images the airglow.

7. The sensor of claim 5 further comprising:
the image process computing system further adapted for determining a roll, pitch and yaw of the sensor on the basis of the attitude in inertial space and the imaged airglow.

8. The sensor of claim 5 further comprising:
the image process computing system further adapted for determining Earth latitude and longitude coordinates directly beneath the sensor on the basis of the attitude in inertial space, the imaged airglow, and a reading of time from a clock.

9. A method for determining pitch and roll of a free-flying vehicle, comprising:
obtaining coordinates of a reference horizon from a reference image of near infrared non-thermal airglow emission in Earth's atmosphere corresponding zero roll and zero pitch;
imaging the near infrared non-thermal airglow emission in Earth's atmosphere which marks the observed horizon;
processing in a computer system the observed horizon image to compute coordinates of the observed horizon; and
comparing the observed horizon coordinates to the reference horizon coordinates to determine the vehicle pitch and roll by measuring the angle of rotation and displacement of the observed horizon with respect to the reference horizon.

10. The method of claim 9 wherein the reference and observed horizon images are of the solar scatter in the vicinity of the horizon.

11. The method of claim 9, further comprising:
observing a celestial body;
identifying the position of the celestial body in the celestial sphere with respect to the Earth by reference to a star catalog; and
determining yaw of the vehicle on the basis of the location of the celestial body with respect to the observed horizon.

12. The method of claim 11, wherein the free-flying vehicle is selected from a group consisting of a high altitude aircraft and a spacecraft in Earth orbit.

13. A method for determining the Earth coordinates directly beneath a free-flying vehicle, comprising:
obtaining an image of at least two celestial objects in a star field of view of a star sensor at a measured time;
identifying the at least two celestial objects;
computing in a computer system a three axis attitude of the vehicle in inertial space on the basis of the identified celestial objects;
obtaining an observed horizon image in the field of view of an Earth horizon sensor at the measured time and storing the observed earth horizon image in a computer system memory;
processing in the computer system the observed Earth horizon image to locate the observed horizon;
obtaining the attitude of the vehicle with respect to the observed horizon on the basis of referencing the boresight of the star sensor relative to the boresight of the Earth horizon sensor at the measured time;
performing celestial formula calculations in the computer system on the basis of the measured time, an inertial attitude and the location of the observed horizon to determine the latitude and longitude of the Earth coordinates directly beneath the vehicle.

14. The method of claim 13, wherein the free-flying vehicle is selected from a group consisting of a high altitude aircraft and a spacecraft in Earth orbit.

15. A device for determining the pitch and roll of a free-flying vehicle, comprising:
at least one component for collecting and focusing an airglow light due to near infrared non-thermal emissions in Earth's atmosphere;
at least one detector array coupled to the optical component, the array adapted for receiving a focused image of the airglow;
an observed image of the airglow detected by the at least one detector array;
a computer system and computer memory for storing the observed image and for determining a horizon plane which is normal to the line connecting the vehicle to the center of the Earth on the basis of the observed image; and
the computer system and memory further adapted for determining the vehicle pitch and roll with respect to the horizon plane.

16. The device of claim 15 wherein the detector array is configured to receive an image of the near infrared solar scatter in the vicinity of the horizon and the observed image is of the same near infrared solar scatter.

17. The device of claim 15, further comprising:
at least one optical component for collecting and focusing light from a field of view containing a star or other celestial body; and
at least one detector array coupled to the at least one optical component, the array configured to receive an image of the star or other celestial body, and the computer system further adapted for identifying the celestial body and its location in the celestial sphere with respect to the Earth by reference to a star catalog, and for determining a yaw of the device on the basis of the location of the celestial body with respect to the observed horizon.

18. The device of claim 17, wherein the device is mounted on a free flying vehicle selected from the group consisting of a high altitude aircraft and a spacecraft in Earth orbit.

19. A device on a free flying vehicle for determining the Earth coordinates directly beneath the free-flying vehicle comprising:
at least one first optical component for collecting and focusing light from at least two celestial objects in a star field of view at a measured time;
at least one first detector array coupled to the first optical component to obtain an image of the two celestial objects;
a computer system and memory coupled to the first detector array to identify the celestial objects by reference to a star catalog stored in the computer memory, to define a three axis attitude of the vehicle in inertial space on the basis of the identified celestial objects;
at least one second optical component for collecting and focusing light from an airglow due to near infrared non-thermal emissions in Earth atmosphere;
at least one second detector array coupled to the second optical component to obtain an observed image of the airglow;
a computer system and memory for storing the observed image of the airglow, for determining the horizon plane which is normal to the line connecting the vehicle to the center of the Earth on the basis of the observed image of the airglow, for obtaining the attitude of the vehicle with respect to the observed horizon plane on the basis of referencing the boresight of the two sets of optical components, and for performing celestial formula calculations corresponding to the measured time, the inertial attitude and the location of the horizon plane to determine the latitude and longitude of the Earth coordinates directly beneath the vehicle.

20. The device of claim 19, wherein the first and the second optical components are the same.

21. The device of claim 19, wherein the first and the second detector arrays are the same.

22. A composite Earth horizon sensor comprising a plurality of Earth horizon sensors according to claim 1, wherein each Earth horizon sensor has a selected field of view, and the composite Earth horizon sensor has a field of view that is equal to or less than the sum of the fields of view of each of the Earth horizon sensors.

23. The composite Earth horizon sensor of claim 22 further comprising:
a plurality of the detector arrays configured to share a common set of optical components; and
a multi-faceted mirror facing and coupled to the plurality of detector arrays and common set of optical components to provide a different field of view to each detector array.

24. The composite Earth horizon sensor of claim 23, wherein at least one of the detectors receives an image of a star field in the field of view.

25. The composite Earth horizon sensor of claim 23, further comprising a star tracking imager coupled to the composite Earth horizon sensor, the star tracker having a star field of view to image stars and facing in a direction different from the composite Earth horizon sensor.
